(19) United States
(12) Patent Application Publication
(10) Pub. No.: US 2025/0187275 A1
(43) Pub. Date: Jun. 12, 2025

(54) A METHOD OF JOINING TPE TUBES

(71) Applicant: WATSON-MARLOW LIMITED, Cornwall (GB)

(72) Inventors: Nicholas White, Cornwall (GB); Daniel Hood, Cornwall (GB)

(73) Assignee: WATSON-MARLOW LIMITED, Cornwall, EN (GB)

(21) Appl. No.: 18/847,155

(22) PCT Filed: Mar. 14, 2023
(86) PCT No.: PCT/EP2023/056526

§ 371 Date: Sep. 13, 2024

(30) Foreign Application Priority Data
Mar. 15, 2022 (GB) 2203607.3

(51) Int. Cl. B29C 65/66; B29C 65/00; B29C 65/72; B29K 21/00; B29L 23/00

(52) U.S. Cl. CPC B29C 65/66; B29C 65/72; B29C 66/5221; B29K 2021/003; B29L 2023/22

(57) ABSTRACT

There is provided a method of joining thermoplastic elastomer (TPE) tubes, comprising: abutting an end surface of a first TPE tube against an end surface of a second TPE tube; providing a TPE sleeve around the first and second tubes such that it overlaps the end surfaces; providing a compression member around the sleeve which is configured to apply a radial force around a circumference of the sleeve; and fusing the first and second tubes and the sleeve to one another by applying heat to the sleeve while applying a radial force to the sleeve using the compression member.

### CROSS-REFERENCE TO RELATED APPLICATIONS

This application is a national phase application claiming benefit of priority to PCT International Application PCT/EP2023/056526, filed Mar. 14, 2023, which claims priority to GB 2203607.3, filed Mar. 15, 2022; wherein the entirety of each of said Applications is incorporated herein by reference.

### TECHNICAL FIELD

The present disclosure relates to a method of joining TPE tubes.

### BACKGROUND

Thermoplastic elastomer (TPE) tubing or other components are commonly used in pharmaceutical and bioprocessing applications owing to their desirable properties. In particular, TPE tubing may be used in conjunction with peristaltic pumps.

TPE tubes may be connected together using mechanical connectors and clamps. However, this provides the potential for contamination and leaks. While TPE tubes can be welded, many welding processes are not suitable due to processing constraints (e.g. material compatibility, cycle times etc.) and quality attributes (e.g. poor surface quality, difficulty in popping open welded join, perception of particulates etc.).

Accordingly, there is need to provide a method of joining TPE tubes which addresses issues associated with existing techniques.

### SUMMARY

According to an aspect of the disclosure, there is provided a method of joining thermoplastic elastomer (TPE) tubes, comprising: abutting an end surface of a first TPE tube against an end surface of a second TPE tube; providing a TPE sleeve around the first and second tubes such that it overlaps the end surfaces; providing a compression member around the sleeve which is configured to apply a radial force around a circumference of the sleeve; and fusing the first and second tubes and the sleeve to one another by applying heat to the sleeve while applying a radial force to the sleeve using the compression member.

The compression member may be a heat shrink tube.

The heat shrink tube may have a length which is a greater than a length of the sleeve and may be arranged such that it overhangs either end of the sleeve.

The sleeve may have an inner diameter which corresponds to the outer diameter of the first and second tubes.

A longitudinal pressure may be applied to the first and second tubes during fusing.

The longitudinal pressure may be applied for only part of the time that heat is applied.

The sleeve may have a wall thickness which is less than a wall thickness of the first and second tubes.

The sleeve may have a wall thickness which is between 25% to 75% of the wall thickness of the first and second tubes.

The wall thickness of the sleeve may be 50% of the wall thickness of the first and second tubes.

The compression member may be removed after fusing.

### BRIEF DESCRIPTION OF THE DRAWINGS

Embodiments will now be described by way of example only, with reference to the drawings, in which:

FIG. 1 is a flowchart of a method according to an embodiment of the disclosure;

FIG. 2 is a cross-sectional view showing a first stage of the method;

FIG. 3 is a cross-sectional view showing a second stage of the method;

FIG. 4 is a cross-sectional view showing a third stage of the method;

FIG. 5 is a cross-sectional view showing a fourth stage of the method; and

FIG. 6 shows a cross-section of a sample following joining.

### DETAILED DESCRIPTION OF PREFERRED EMBODIMENTS

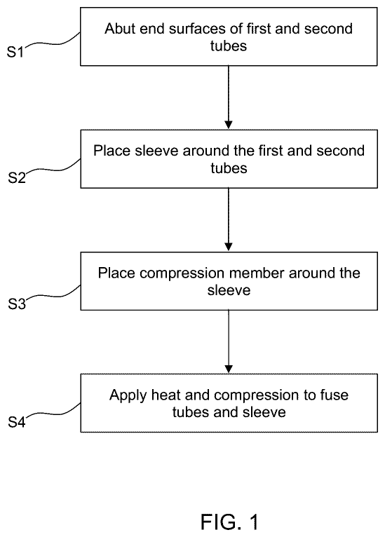

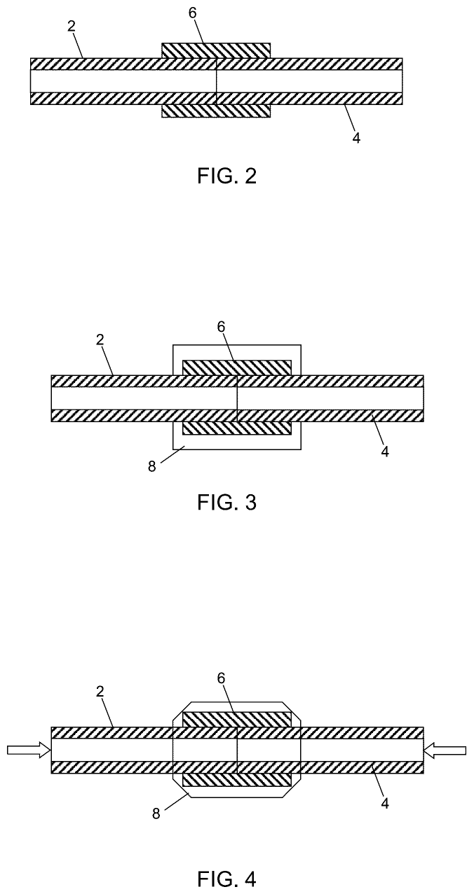

FIG. 1 depicts a method of joining two thermoplastic elastomer (TPE) tubes which will be described with reference to FIGS. 2 to 4.

In a first step, S1, an end surface of a first tube 2 is abutted against an end surface of a second tube 4, as shown in FIG. 2.

In this example, the first and second tubes 2, 4 have the same inner diameter (i.e., bore size), outside diameter and wall thickness. The first and second tubes 2, 4 are arranged such that the bores are aligned at the interface between the first and second tubes 2, 4. The first and second tubes 2, 4 may be prepared so as to ensure that they are clean and that the end surfaces are perpendicular.

The first and second tubes 2, 4 may have an inner diameter of between 0.5 mm and 25.4 mm and a wall thickness of between 1.6 mm and 4.8 mm. For example, the tubes may range from a tube having an inner diameter of 0.5 mm and a wall thickness of 1.6 mm (thus, with an outside diameter of 3.7 mm) to a tube having an inner diameter of 25.4 mm and a wall thickness of 4.8 mm (thus, with an outside diameter of 35 mm). In this example, the tubes 2, 4 have an inner diameter of 12.7 mm, a wall thickness of 3.2 mm and thus an outside diameter of 19.1 mm.

In a second step, S2, a TPE sleeve 6 (which may be the same grade as the first and second tubes 2,4) is provided around the first and second tubes 2, 4 such that it overlaps the end surfaces at the interface between the first and second tubes 2, 4. In this example, the interface between the first and second tubes 2, 4 is located centrally in the sleeve 6 such that the sleeve 6 extends an equal distance over the first and second tubes 2, 4.

The sleeve 6 is a short length of tube which has an inner diameter that corresponds to the outside diameter of the first and second tubes 2, 4. In this example, the inner diameter of the sleeve 6 is therefore 19.1 mm. In other examples, the sleeve 6 may have an inner diameter which is less than the outside diameter of the first and second tubes 2, 4 such that there is an interference fit between the first and second tubes 2, 4 and the sleeve 6. The sleeve 6 and/or first and second tubes 2, 4 may be sufficiently soft (i.e., have a sufficiently low durometer hardness value) in order to permit sufficient deformation to allow the first and second tubes 2, 4 to be easily inserted into the sleeve 6. Where an interference fit is provided, it will be appreciated that the inner diameter of the sleeve 6 corresponds to the outside diameter of the first and second tubes 2, 4 once the first and second tubes 2, 4 are inserted into the sleeve 6. The sleeve 6 may have a wall thickness which is less than the wall thickness of the first and second tubes 2, 4. For example, the wall thickness of the sleeve 6 may be 25% to 75% of the wall thickness of the first and second tubes 2, 4. In this example, the sleeve 6 has a wall thickness of 1.6 mm and thus is 50% of the wall thickness of the first and second tubes 2, 4. In this example, the sleeve 6 has a length of 20 mm, although in other examples the sleeve 6 may have a different length.

The sleeve 6 may be slid fully onto the first tube 2 and then partially slid back over the second tube 4 once the end surfaces are abutted against one another. Alternatively, the sleeve 6 may be slid partially onto the first tube 2 and then the second tube 4 may be inserted into the sleeve 6 until it abuts against the first tube 2.

As shown in FIG. 3, in a third step, S3, a compression member is placed around the sleeve 6. In this example, the compression member is a heat shrink tube 8 which may be formed from polyolefin or any other heat shrinkable material. As shown, the heat shrink tube 8 has a length which is greater than the length of the sleeve 6 and so extends beyond either end of the sleeve 6. The heat shrink tube 8 is positioned so as to provide an equal overhang beyond either end of the sleeve 6. In this example, the heat shrink tube 8 has a length of 35 mm and so overhangs by approximately 7.5 mm beyond either end of the sleeve 6. It is desirable that the heat shrink tube 8 has a length (L_{HST}) which is greater than the length (L_{S}) of the sleeve 6 plus the wall thickness (WT_{S}) of the sleeve 6 at either end (i.e., L_{HST}≥L_{S}+2WT_{S}). The length of the heat shrink tube 8 may also reduce during heating (by about 5 to 10%) and this should be taken into account (i.e., added) when determining the desired length.

The heat shrink tube 8 has an inner diameter (as supplied) which is greater than the outside diameter of the sleeve 6. In this example, the inner diameter of the heat shrink tube 8 is 25.4 mm (compared to the outside diameter of the sleeve of 22.3 mm). The heat shrink tube 8 has a shrinkage ratio of 2:1, although other shrinkage ratios may be suitable.

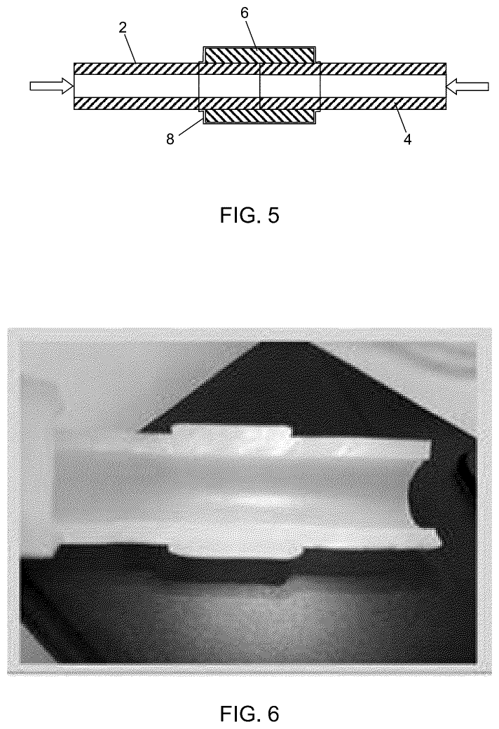

As shown in FIGS. 4 and 5, in a fourth step, S4, heat is applied to the assembly, and particularly the heat shrink tube 8. This causes the heat shrink tube 8 to shrink into engagement with the outer surface of the sleeve 6. The heat shrink tube 8 therefore compresses the sleeve 6 and applies a radial force around the circumference of the sleeve 6 while the assembly continues to be heated. The heat shrink tube 8 has sufficient length so that it entirely covers the ends of the sleeve 6 and also contacts the outer surface of the first and second tubes 2, 4 over a small portion either side of the sleeve 6.

While heat is applied to the assembly, in addition to the radial force applied by the heat shrink tube 8, longitudinal pressure (denoted by the arrows) is applied across the tubes 2, 4 such that the end surfaces are forced together.

In this example, the heat is applied by hot air from a heat gun. The heat gun is set at a temperature of 300° C. and is applied across the area for a total of 80 seconds. The longitudinal pressure is applied to the tubes 2, 4 for only part of the time that heat is applied. In particular, in this example, the longitudinal pressure is applied for the first 30 seconds only.

The heat, compression and longitudinal pressure creates fusion between the end surfaces of the first and second tubes 2, 4 and also between the inner surface of the sleeve 6 and the outer surfaces of the first and second tubes 2, 4. Accordingly, the first and second tubes 2, 4 and sleeve 6 are fully fused to create a single, integrally formed component, as shown in the sample of FIG. 6.

In the sample of FIG. 6, the heat shrink tube 8 is removed from the assembly after heating. In other examples, the heat shrink tube 8 may be left on the assembly.

Although the method has been described as using a heat shrink tube 8, it will be appreciated that other forms of compression member may be used which apply a radial pressure around the circumference of the sleeve to assist with fusion. For example, the compression member may be a mechanical device, such as an inflatable ring, which has a variable diameter that can be constricted to apply a radial force to the sleeve 6.

The ends of the sleeve 6 (or a portion thereof) may be inclined such that they are not perpendicular to the outer surface of the first and second tubes 2, 4 and thus taper into the outer surface of the first and second tubes 2, 4 so as to avoid an abrupt step and reduce the risk of restricting the inner bore. Alternatively, the tapering of the sleeve 6 may be formed as it is melted. This may be achieved by applying an additional force to the sleeve 6 to press material laterally away from the ends of the sleeve 6.

It will be appreciated that one of the tubes may form part of a connector component, such as cross, Y or T fitting or a flange component for use in a clamp. The sleeve 6 and heat shrink tube 8 (or other compression member) may be provided with the connector component. Where the connector comprises multiple legs (as with cross, Y and T fittings), the legs may be simultaneously connected to separate tubes. For example, a single heat gun may be provided with an adaptor manifold which provides hot air to each of the legs at the same time.

Although not shown, one or both of the tubes and/or connector components may be provided with a shoulder, such as a flange or boss, against which the sleeve 6 abuts in order to position the sleeve 6 in a longitudinal direction.

The disclosure is not limited to the embodiments described herein, and may be modified or adapted without departing from the scope of the present disclosure.

1. A method of joining thermoplastic elastomer (TPE) tubes, comprising the steps of:
abutting an end surface of a first TPE tube against an end surface of a second TPE tube;
providing a TPE sleeve around the first and second tubes such that it overlaps the end surfaces;
providing a compression member around the sleeve which is configured to apply a radial force around a circumference of the sleeve; and
fusing the first and second tubes and the sleeve to one another by applying heat to the sleeve while applying a radial force to the sleeve using the compression member.

2. The method as claimed in claim 1, wherein the compression member is a heat shrink tube.

3. The method as claimed in claim 2, wherein the heat shrink tube has a length which is a greater than a length of the sleeve and is arranged such that it overhangs either end of the sleeve.

4. The method as claimed in clam 1, wherein the sleeve has an inner diameter which corresponds to the outer diameter of the first and second tubes.

5. The method as claimed clam 1, wherein a longitudinal pressure is applied to the first and second tubes during fusing.

6. The method as claimed in claim 5, wherein the longitudinal pressure is applied for only part of the time that heat is applied.

7. The method as claimed in clam 1, wherein the sleeve has a wall thickness which is less than a wall thickness of the first and second tubes.

8. The method as claimed in claim 7, wherein the sleeve has a wall thickness which is between 25% to 75% of the wall thickness of the first and second tubes.

9. The method as claimed in claim 8, wherein the wall thickness of the sleeve is 50% of the wall thickness of the first and second tubes.

10. The method as claimed in claim 1, wherein the compression member is removed after fusing.
